(19) United States
(12) Patent Application Publication
(10) Pub. No.: US 2005/0268559 A1
(43) Pub. Date: Dec. 8, 2005

(54) Rollable door seal with integral intumescent strips

(76) Inventor: Robert T. Ellingson, Social Circle, GA (US)

Correspondence Address: WOMBLE CARLYLE SANDRIDGE & RICE, PLLC, P.O. BOX 7037, ATLANTA, GA, 30357-0037, US

(21) Appl. No.: 11/129,961

(22) Filed: May 16, 2005

Related U.S. Application Data
(60) Provisional application No. 60/573,509, filed on May 21, 2004.

(51) Int. Cl. E06B 1/70

(52) U.S. Cl. 49/475.1

(57) ABSTRACT

A door seal system is provided for forming a seal between a closed door and its door frame. The system includes a unitary co-extruded seal member having first and second legs connected by a flexible hinge. A traditional flexible seal is formed along one leg and, preferably, a strip of intumescent material is formed along the other leg. The member can be folded flat along the hinge line for rolling into a compact storage and shipping configuration. For installation, a length is pulled from the roll, cut off, bent into a right angle along the hinge, and fixed to the door frame with one leg extending along the jamb and the other extending along the stop. The flexible seal bears and seals against the outside face of a closed door and the intumescent strip is positioned in the gaps between the door edges and the door frame.

### REFERENCE TO RELATED APPLICATION

Priority is hereby claimed to the filing date of U.S. provisional patent application Ser. No. 60/573,509 filed on May 21, 2004.

### TECHNICAL FIELD

This invention relates generally to entryway systems and more specifically to seals for sealing around a closed door of an entryway system.

### BACKGROUND

Flexible door and weather seals are common in modern entryways to prevent drafts through a closed door. In many commercial applications, such as in hotels, flexible seals may be provided on interior doors to dampen noise or prevent drafts. Fire and smoke seals also are common, particularly in commercial buildings, and may be required in some fire districts. Many commercial door seals are made from two or more pieces, one piece being an elongated aluminum strip and the second piece being a flexible rubberized seal member attached to the metal strip. The metal strip is attached to a door jamb with the rubberized seal contacting and sealing against a closed door. Single piece extruded plastic seals also have been available, some with an adhesive backing that allows them to be attached adhesively to a door jamb. Smoke seals incorporating intumescent strips that expand in the presence of the heat of a fire also have been available. Such smoke seals are attached in various ways to door jambs within the gaps between a closed door and the jamb so that when the seals expand in the event of a fire, they fill these gaps and prevent smoke infiltration.

Prior art door seals have had various problems and shortcomings. For instance, multi-piece seals with a metal portion and attached rubberized seals must be sized and cut carefully for installation. Further, these types of seals necessarily are manufactured in long strips, which presents storage and shipping problems because of their size. To the extent that flexible coilable door seals have been available, they usually have been made of felt or soft rubberized plastic and generally are too flimsy for commercial applications. Smoke seals in the form of intumescent strips generally have been separate items that are installed in addition to standard door seals, which is inconvenient and inefficient. A need exists for a door seal system that is rollable into a compact configuration for storage and shipping, that is sufficiently robust for commercial applications when installed, that is easily and efficiently installed, and that can incorporate both a traditional seal and a smoke seal that each is properly positioned when the system is installed in a doorway. It is to the provision of such a door seal system that the present invention is primarily directed.

### SUMMARY OF THE INVENTION

Briefly described, the present invention is a door seal system that successfully addresses the problems and shortcomings of the prior art. The system includes a unitary co-extruded one-piece plastic seal member. The seal member has first and second legs made of a relatively hard plastic and that are interconnected by a co-extruded flexible hinge made of a softer flexible plastic. In a preferred embodiment, a traditional flexible rubberized seal is co-extruded along the first leg and a strip of intumescent material is co-extruded or otherwise applied to the second leg. The seal member is co-extruded in long strips. For storage and shipping, the two legs are hinged or folded into a flat co-extensive configuration and the member can be rolled or coiled into a relatively compact roll. For installation, an appropriate length is cut from the roll and folded along the hinge so that the first leg forms a substantial right angle relative to the second leg. The folded member is then applied to a door frame, preferably with a previously applied adhesive backing, with the first leg extending along the door stop and the second leg extending along the jamb next to the stop. When the door is shut, the flexible seal on the first leg bears and seals against the outside face of the door around the door edges to seal against drafts. The intumescent strip on the second leg, which does not normally contact the door, is properly positioned in the gaps between the door edges and the jamb. In the event of a fire, resulting heat causes the intumescent strip to expand and fill these gaps to prevent smoke infiltration.

Thus, the door seal system of this invention is economically manufactured in a single co-extrusion process, is coilable into a compact configuration for storage and shipping, is easily installed, is sufficiently rugged for commercial applications, and provides both a traditional seal and a smoke seal in one convenient easily installed package. These and other features, objects and advantages of the invention will become more apparent upon review of the detailed description presented below when taken in conjunction with the accompanying drawing figures, which are briefly described as follows.

### BRIEF DESCRIPTION OF THE DRAWINGS

FIG. 1 is a cross-sectional view of a portion of a entryway system depicting the region of the door stop and showing one embodiment of a door seal system that embodies principles of the invention in one preferred form.

FIG. 2 illustrates the door seal system of FIG. 1 in its flat configuration for coiling and storage.

FIG. 3 illustrates another embodiment of a door seal system that embodies principles of the invention.

FIG. 4 illustrates yet another embodiment of a door seal system that embodies principles of the invention.

FIG. 5 illustrates still another embodiment of a door seal system that embodies principles of the invention.

### DETAILED DESCRIPTION OF THE PREFERRED EMBODIMENTS

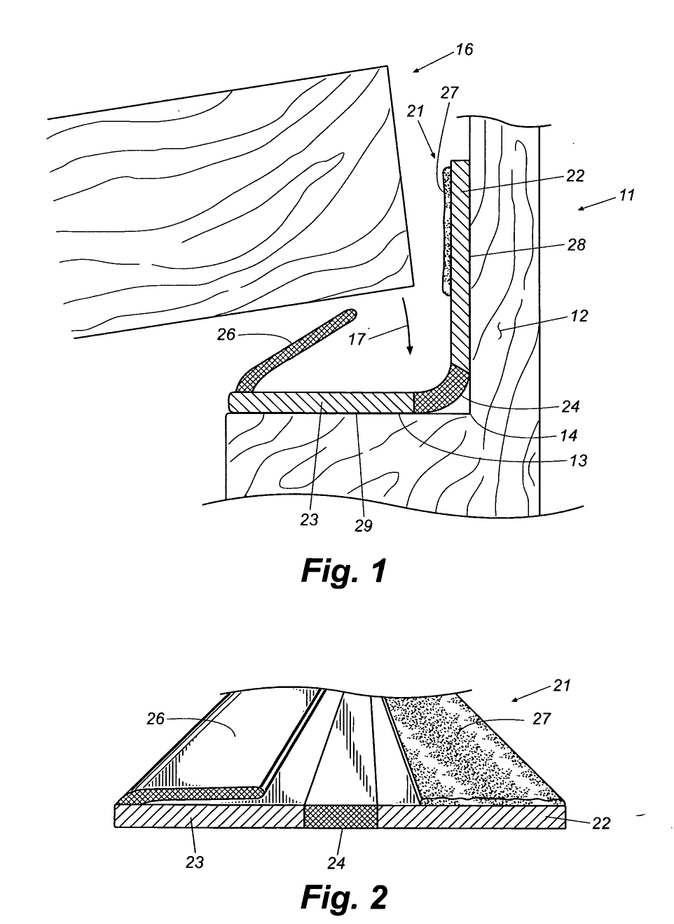

Referring now in more detail to the drawing figures, wherein like reference numerals designate, where appropriate, like parts throughout the several views, FIG. 1 shows one preferred embodiment of the door seal system of the present invention. This figure is a cross-sectional view of a relatively small portion of an entryway in the vicinity of the raised door stop thereof. The entryway 11 has a jamb 12 that is formed with a raised stop 13 against which a door 16 closes. A corner 24 is defined along the junction of the jamb 12 and the raised stop 13. The door 16 of the entryway is hinged and is closable in the traditional way, as indicated by arrow 17. It will be understood that the jamb configuration of FIG. 1 is simplified for purposes of illustrating clearly the advantages of the present invention. More complex jamb configurations, which may have curfs and other profiles, are common and all door jamb configurations should be considered to be within the scope of the present invention.

A door seal system, configure according to the present invention, is installed in the entryway system spanning the corner 14. The door seal system comprises a seal member 21 that preferably is made from a unitary piece of co-extruded plastic material and includes a first leg 23 and a second leg 22, each composed of a relatively hard and rigid plastic such as PVC, ABS, or any other appropriate plastic. The first and second legs 23 and 22 are joined together along corresponding edges by a co-extruded flexible hinge 24, which is composed of a relatively low durometer flexible or rubberized plastic material. The hinge 24 allows the seal member 21 to be hinged or bent easily along the length of the hinge so that the seal member fits snuggly within the corner 14 between the jamb 12 and stop 13 as illustrated. Preferably, the seal member is attached to the entryway by means of pre-applied adhesive backings 28 and 29 applied along the back sides of the legs 23 and 22 respectively. However, attachment may be by post applied adhesive, screws, nails, or any other appropriate fastening mechanism.

A flexible rubberized seal 26 is co-extruded with and extends along the length of the first leg 23 facing the outside face of the door 16 as the door is shut. In this embodiment, the seal 26 is a flexible fin that projects outwardly at an angle from the edge of the leg 23 toward the door. As the door shuts, the flexible fin engages and is flexed by the door toward the leg 23. In this way, the flexible fin bears against and forms a seal with the outside face of the door around the edges thereof to form a seal against sound and drafts in the traditional way.

A strip 27 of intumescent material preferably is co-extruded with, but may be otherwise applied to, the second leg 22. The intumescent material may be any appropriate material that expands in the presence of heat such as, for instance, a Graphite Intumescent Sealing Material available from the 3M Corporation of St. Paul, Minn. In any event, the strip 27 of intumescent material extends along the length of the second leg 22 and, when the seal member is installed as shown, is positioned so that it resides in the gaps between the edges of a closed door and the face of the jamb 12. In normal use, the strip 27 does not contact the edges of the closed door. However, in the event of a fire, the resulting heat causes the strip to expand to several times its thickness, according to the properties of intumescent materials, to fill and seal these gaps to prevent infiltration of smoke from one side of the door to the other.

As mentioned above, the seal member of this invention is rollable into a compact coiled configuration for storage and shipping. FIG. 2 illustrates the seal member 21 shown in FIG. 1 as it appears after extrusion and configured for being rolled into a coil. Here, the seal member 21 is folded down flat along the flexible hinge 24 so that the first and second legs 23 and 22 are substantially co-extensive with each other. Further, the flexible fin 27 also is folded down onto the first leg 23. While the plastic material of the legs 23 and 22 is sufficiently rigid to support the flexible seal and intumescent strip when installed, it nevertheless is sufficiently flexible to allow the flattened seal member 21 to be flexed or rolled along its length. Accordingly, in this configuration, the seal member of this invention is easily rolled into a coiled configuration for shipping and storage. Further, exceedingly long lengths of the seal member, enough for numerous door installations, can be rolled up in this fashion. During installation, an appropriate length is unrolled from the coil, cut with a standard snip or matt knife, bent along the hinge 24, and applied to the doorway in its installed configuration as shown in FIG. 1.

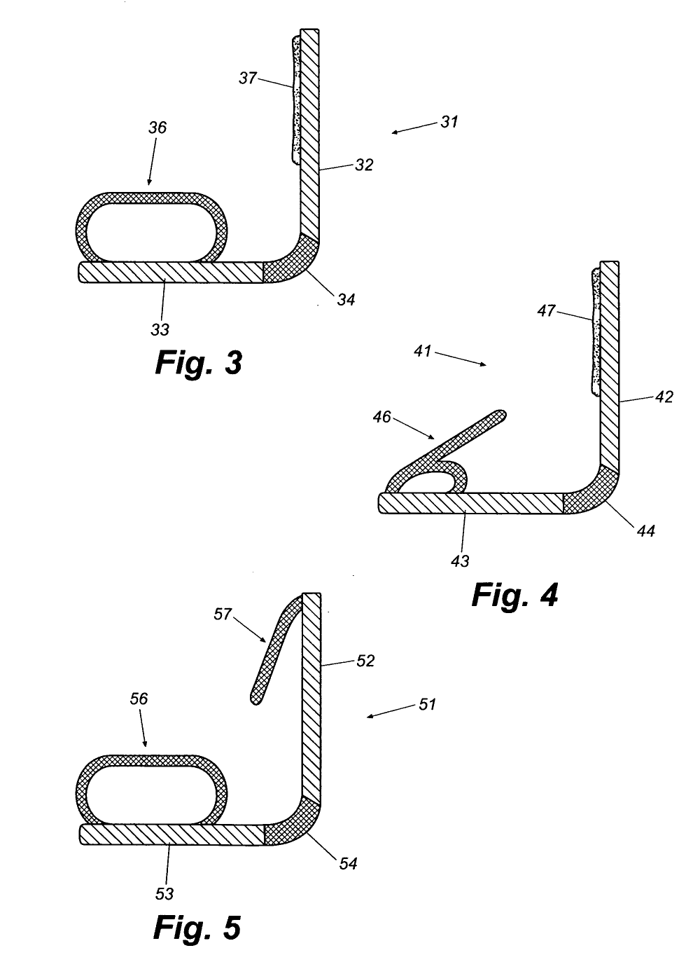

FIGS. 3-5 illustrate alternate embodiments of the door seal system of the present invention. In FIG. 3, a seal member 31 has first and second legs 33 and 32 connected by a co-extruded flexible hinge 34. An intumescent strip 37 is co-extruded with or otherwise applied to the second leg 32 and a flexible seal 36 is co-extruded along the first leg 33. In this embodiment, the flexible seal 36 takes the form of a long bulb seal rather than a flexible fin as in FIG. 1.

FIG. 4 illustrates yet another embodiment of a seal system having a seal member 41 with legs 43 and 42 connected by flexible hinge 44, an intumescent strip 47 extending along leg 42, and a flexible seal 46 co-extruded along leg 43. Here, the flexible seal is configured with a partial bulb seal with the addition of a flexible fin. FIGS. 3 and 4 illustrate that any configuration of flexible seal is possible and within the scope of the invention. Thus, the term “flexible seal” should be construed to encompass any configuration and construction that forms a seal against the face of a door when the door is shut.

Finally, FIG. 5 illustrates an embodiment of the invention that includes a double flexible seal rather than one flexible seal and an intumescent strip. Here, the seal system includes a seal member 51 with a first leg 53 and a second leg 52 interconnected by a co-extruded flexible hinge 54. A flexible bulb seal 56 is co-extruded along leg 53. However, unlike previously discussed embodiments, the second leg 52 is not provided with an intumescent strip. Rather, the second leg 52 has a co-extruded flexible fin 57. Accordingly, this embodiment of the invention provides a double seal against drafts and noise, but does not provide and intumescent seal. Nevertheless, it can be folded flat and rolled into a coil as with other illustrated embodiments for convenient storage and shipping, which is one primary advantage of the present invention.

The invention has been described herein in terms of preferred embodiments and methodologies. It will be understood by those of skill in the art that a wide variety of additions, deletions, and modifications might be made to the illustrated embodiments without departing from the spirit and scope of the invention. For instance, while various configurations of flexible seals have been illustrated in the preferred embodiments, the invention is not limited to any particular configuration. Any type of flexible seal might be incorporated. The material forming the intumescent strip preferably is co-extruded as a unitary part of the system; however, the invention is not limited in this way and the strip can be applied after extrusion if desired. A prime aspect of the invention is its ability to be extruded economically as a unitary piece, configured for rolling into a compact coil, and unrolled and configured for installation. Furthermore, although in the preferred embodiment the entire seal member is co-extruded of plastics materials, the invention is not limited to all plastic co-extrusions. It may be suitable, for instance, that the first and second legs be made of metal such as aluminum connected together by a separate rubberized hinge. Any combination of materials may therefore be selected as an alternative to co-extruded plastic materials, all within the scope of the invention. These and other modifications to the illustrated embodiments are possible without departing from the spirit and scope of the invention as set forth in the claims.

1. A rollable door seal for installation in an entryway to seal around a closed door of the entryway, said door seal comprising:
an elongated first leg having an edge;
an elongated second leg having an edge;
a flexible hinge connecting said edge of said first leg to said edge of said second leg; and
a flexible seal formed along the length of at least one of said legs;
said door seal having a first configuration allowing said door seal to be rolled along its length for storage and shipping and a second configuration for installation in said entryway.

2. A rollable door seal as claimed in claim 1 and wherein said first and second legs are made of plastic.

3. A rollable door seal as claimed in claim 2 and wherein said first and second legs are co-extruded with said flexible hinge.

4. A rollable door seal as claimed in claim 1 and further comprising an strip of intumescent material disposed along at least one of said legs.

5. A rollable door seal as claimed in claim 4 and wherein said first and second legs are plastic and wherein said strip of intumescent material is co-extruded with said one of said legs.

6. A rollable door seal as claimed in claim 1 and further comprising a flexible seal formed along each of said legs.

7. A rollable door seal as claimed in claim 1 and wherein said flexible seal comprises a bulb seal.

8. A rollable door seal as claimed in claim 1 and wherein said flexible seal comprises a fin seal.

9. A rollable door seal as claimed in claim 1 and wherein said flexible seal comprises a combination bulb seal and fin seal.

10. A rollable door seal as claimed in claim 1 and further comprising an adhesive backing on said door seal for securing said door seal to an entryway.

11. A rollable door seal for installation in an entryway having a door jamb formed with a raised stop against which a hinged door is closed, said rollable door seal comprising:
first and second elongated legs connected together along corresponding edges by a relatively flexible hinge;
said hinge allowing said door seal to have a first configuration wherein said legs are substantially co-extensive and said door seal can be rolled along its length into a roll and a second configuration wherein said legs are oriented at an angle relative to each other for installation along the raised stop of the jamb; and
a flexible seal formed along one of said legs, said flexible seal being configured and positioned, when said door seal is installed, to bear against the closed door of the entryway and form a seal therewith.

12. A rollable door seal as claimed in claim 11 and further comprising a strip of intumescent material extending along the other one of said legs.

13. A rollable door seal as claimed in claim 12 and wherein said first and second legs are formed of plastic and wherein said intumescent strip is co-extruded with said other one of said legs.

14. A rollable door seal as claimed in claim 13 and wherein said one of said legs is formed of plastic and wherein said flexible seal is co-extruded with said one of said legs.

15. A rollable door seal as claimed in claim 11 and further comprising a second flexible seal extending along the other one of said legs.

16. A rollable door seal as claimed in claim 11 and wherein said first and second legs and said flexible hinge are co-extruded of plastic material.

17. A rollable door seal as claimed in claim 16 and wherein said first and second legs are made of a relatively more rigid plastic material and said hinge is made of a relatively less rigid plastic material.

18. A rollable door seal as claimed in claim 16 and wherein said flexible seal is co-extruded with said one of said legs.

19. A door seal comprising first and second elongated legs connected by a flexible hinge and a flexible seal extending along said first elongated leg, said door seal being bendable along said hinge between a first configuration for rolling into a roll and a second orientation for installation in an entryway with said flexible seal sealing against a closed door of the entryway.

20. A door seal as claimed in claim 19 and further comprising a flexible seal extending along said second leg.

21. A door seal as claimed in claim 19 and further comprising a strip of intumescent material extending along said second leg.

22. A door seal as claimed in claim 21 and wherein said first and second legs, said flexible seal, said flexible hinge, and said intumescent strip are co-extruded as a unitary component.

23. A door seal comprising first and second elongated legs connected by a flexible hinge and a strip of material extending along one of said legs, said strip of material being selected from the group consisting essentially of a flexible seal and an intumescent material, said door seal being bendable along said hinge between a first configuration for rolling into a roll and a second configuration for installation in an entryway with said flexible seal sealing against a closed door of the entryway.

24. A method installing a door seal in an entryway comprising the steps of bending the door seal along its length into a substantially L-shaped configuration and attaching the bent door seal to an entryway.

25. The method of claim 24 and wherein said entryway includes a door jamb with a raised stop and wherein the step of attaching the bent door seal comprising securing the door seal along the raised stop.

26. A rollable plastic door seal comprising a first leg of relatively rigid plastic, a second leg of relatively rigid plastic, and a hinge of relatively flexible plastic connecting said first and second legs, said door seal being bendable along said hinge between a first configuration wherein said first and second legs are substantially co-extensive and said door seal can be rolled up for storage and a second configuration wherein said first and second legs extend at an angle relatively to each other for installation in an entryway, and a strip of material extending along at least one of said legs, said strip of material being selected from the group consisting essentially of a flexible seal and intumescent material.

27. A rollable plastic door seal as claimed in claim 26 and wherein said first and second legs, said hinge, and said strip of material are co-extruded to form a unitary construction of said door seal.
